(19) United States
(12) Patent Application Publication
(10) Pub. No.: US 2025/0368085 A1
(43) Pub. Date: Dec. 4, 2025

(54) METHOD FOR CHARGING AN ELECTRIC MOTOR VEHICLE

(71) Applicant: Volkswagen Aktiengesellschaft, Wolfsburg (DE)

(72) Inventors: Torsten STICHOWSKI, Magdeburg (DE); Ralf BORNGRAEBER, Lehre (DE)

(73) Assignee: Volkswagen Aktiengesellschaft, Wolfsburg (DE)

(21) Appl. No.: 19/224,040

(22) Filed: May 30, 2025

(30) Foreign Application Priority Data
May 30, 2024 (DE) 10 2024 205 042.3

(51) Int. Cl. B60L 53/66; G06F 21/44

(52) U.S. Cl. CPC B60L 53/665; G06F 21/44

(57) ABSTRACT

A method and system for charging an electric motor vehicle at a charging station. A communication link is established between the motor vehicle and the charging station, via which a charging operation is enabled by linking with authorization data, characterized in that the authorization data are not stored in the motor vehicle, and the authorization data are linked with the motor vehicle by an interaction with a person.

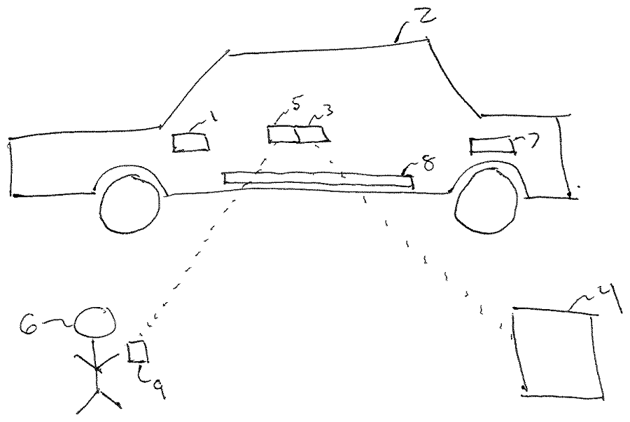

This nonprovisional application claims priority under 35 U.S.C. § 119 (a) to German Patent Application No. 10 2024 205 042.3, which was filed in Germany on May 30, 2024, and which is herein incorporated by reference.

### BACKGROUND OF THE INVENTION

### Field of the Invention

The invention relates to a method for charging an electric motor vehicle at a charging station.

### Description of the Background Art

A motor vehicle that includes at least one electric traction motor via which the sole drive of the motor vehicle is possible is considered to be an “electric motor vehicle.” The motor vehicle may include only the at least one electric traction motor (“electric vehicle”), or the at least one electric traction motor may be provided in addition to some other drive device, in particular an internal combustion engine (“hybrid vehicle”). Supplying the at least one electric traction motor of such an electric motor vehicle with power generally takes place using a (traction) battery. For charging such a traction battery, an electric motor vehicle typically includes a charging connection to a plug connector to which a mating plug connector of an external charging station is connectable.

Enabling a charging operation by the charging station is necessary for charging the traction battery of an electric motor vehicle at a public charging station. For this purpose, the charging station checks whether an authorization for use is present, which generally also requires at least enabling of data, linked with the authorization, for payment for the electrical energy purchased during the charging operation.

For the most convenient charging of a motor vehicle possible, a function usually referred to as “plug and charge” is known, in which authorization for use of a charging station and the data necessary for this purpose are stored in the motor vehicle and transferred to the charging station, for example when a charging connection of the motor vehicle is connected to the charging station, so that charging of the traction battery can take place directly or without further interaction on the part of a person associated with the motor vehicle (see EP 4 219 225 A1, which is incorporated herein by reference). For use of this plug and charge function, it is generally necessary for a person, in particular the owner of the motor vehicle, to enter into an appropriate charging contract with a charging station operator, and for this contract to then be associated with the motor vehicle.

It is disadvantageous that the charging contract is then coupled to the motor vehicle. Therefore, the vehicle owner cannot readily use this charging contract for charging some other motor vehicle, for example a rental motor vehicle.

WO 2020/256305 A1, which is incorporated herein by reference, discloses a method that proposes to recommend a travel route with tourist attractions for a driver of an electric rental vehicle, and via gamification prompts the driver to spend time at a tourist attraction for a relatively long period of time while the bidirectionally chargeable rental vehicle participates in an electricity exchange.

### SUMMARY OF THE INVENTION

It is therefore an object of the invention to allow use of a charging contract in the most convenient manner possible, regardless of the vehicle.

According to an example of the invention, a method for charging an electric motor vehicle at a charging station is provided, wherein a communication link for a data exchange between the motor vehicle and the charging station is established, via which a charging operation is enabled by linking the charging operation to authorization data. The authorization data are data that indicate to the charging station that a charging operation can be carried out.

It may preferably be provided that the authorization data are or include data concerning a charging contract and/or payment data. A “charging contract” can be considered to be a contract between a (natural or legal) person associated with the motor vehicle, and a (natural or legal) person, associated with the charging station, who operates the charging station and thus provides the electrical energy required for charging the motor vehicle. “Payment data” are data that allow the charging station or person associated with same to at least bill for costs for providing the electrical energy, and in particular to directly arrange for payment therefor.

The method includes the feature that the authorization data are not stored in the motor vehicle, but, rather, are linked with a motor vehicle only by a defined interaction with a person associated with the motor vehicle. An interaction is basically considered to be any interaction of the motor vehicle with the person, wherein this interaction may take place directly or indirectly, in the latter case in particular via a device that is associated with the person and that does not represent a part of the motor vehicle.

The method may provide that the authorization data are associated over the long term with the person, not with the motor vehicle. In contrast, an association or linkage of the authorization data with the motor vehicle takes place only for one charging operation, in addition it being provided that a communication for transmitting the authorization data to the charging station takes place via the motor vehicle as a communication center, which allows convenient charging of the motor vehicle that is possibly interaction-free on the part of the person associated with the motor vehicle, as is familiar from the known plug and charge function.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein the sole FIGURE illustrates the system according to an example of the invention.

### DETAILED DESCRIPTION

A charging control device 1 for an electric motor vehicle 2 that is configured to carry out a method according to the invention includes at least a first communication interface 3 that is configured to provide a communication link with a charging station 4, and a second communication interface 5 that is configured to interact with a person 6 associated with the motor vehicle, the charging control device being further configured to receive authorization data for enabling a motor vehicle via the interaction with the person, and to transfer the authorization data to the charging station.

The invention further relates to an electric motor vehicle having such a charging control device. The motor vehicle also includes at least one electric traction motor 7 and a traction battery 8. The motor vehicle may in particular be a wheel-based, not rail-bound, motor vehicle (preferably a passenger car, bus, or truck).

The linkage of the authorization data with the motor vehicle may take place only for the one charging operation or a defined, limited or unlimited plurality of charging operations (including the specific charging operation) with the specific motor vehicle, or for a defined, limited or unlimited period of time. It may be provided that an appropriate selection may be made by the person within the scope of the interaction, or has already been made in advance.

For an indirect interaction of the motor vehicle with the person, it may preferably be provided that the authorization data are stored on a mobile communication device 9 that is associated with the person associated with the motor vehicle 2 and communicatively linked with the motor vehicle 2, and/or retrieved by the mobile communication device from a (vehicle-) external data memory and transferred to the motor vehicle. For this purpose, the charging control device according to the invention may preferably be designed in such a way that the second communication interface is configured to provide a communication link with the mobile communication device.

The mobile communication device may preferably use a customary data transmission standard, for example 4G or 5G, for a data transfer. The mobile communication device may in particular be a conventional mobile telephone or smart phone, optionally having an application (“app”) that is specifically provided for the interaction.

The data memory may in particular be in the possession, in particular also in the ownership, of the person associated with the charging station.

For a direct interaction of the motor vehicle with the person associated with the motor vehicle, it may preferably be provided that the motor vehicle has an operating system that retrieves the authorization data from an external data memory, based on an interaction with the person associated with the motor vehicle. For the data retrieval, the operating system may preferably use its own data transfer device, or a data transfer device that is included in the charging control device, and that preferably uses a customary data transmission standard, for example 4G or 5G, for a data transfer. Additionally or alternatively, a data transfer function that is provided by the mobile communication device may be used. For this purpose, a charging control device according to the invention may preferably be designed in such a way that the second communication interface has an operating system that is configured to retrieve the authorization data from an external data memory, based on an interaction with the person. The interaction may include input of data by the person to an input device, for example a screen, of the operating system. Voice input of the data may alternatively or supplementally be provided.

A direct or indirect interaction of the charging control device with the person associated with the motor vehicle may include an authentication of the person by the mobile communication device, for example by inputting a PIN and/or a password and/or by means of facial and/or fingerprint recognition, before the authorization data are transferred to the motor vehicle.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for charging an electric motor vehicle at a charging station, the method comprising:
establishing a communication link between the motor vehicle and the charging station; and
enabling a charging operation, via the established communication link, by linking with authorization data,
wherein the authorization data are not stored in the electric motor vehicle, and
wherein the authorization data are linked with the electric motor vehicle by an interaction with a person.

2. The method according to claim 1, wherein the linkage of the authorization data with the motor vehicle takes place only for the one charging operation or a defined, limited or unlimited plurality of charging operations with the motor vehicle, or for a defined, limited or unlimited period of time.

3. The method according to claim 1, wherein the authorization data are stored on a mobile communication device that is associated with the person and communicatively linked with the motor vehicle, and/or retrieved by the mobile communication device from an external data memory.

4. The method according to claim 1, wherein the motor vehicle has an operating system that retrieves the authorization data from an external data memory, based on an interaction with the person.

5. The method according to claim 4, wherein the interaction includes input of data by the person to an input device of the operating system.

6. A charging control device for an electric motor vehicle, the charging control device comprising:
a first communication interface that is configured to provide a communication link with a charging station; and
a second communication interface that is configured to interact with a person,
wherein the charging control device is configured to receive authorization data for enabling a motor vehicle via the interaction with the person, and to transfer the authorization data to the charging station.

7. The charging control device according to claim 6, wherein the second communication interface is configured to provide a communication link with a mobile communication device associated with the person.

8. The charging control device according to claim 6, wherein the second communication interface has an operating system that is configured to retrieve the authorization data from an external data memory, based on an interaction with the person.

9. The charging control device according to claim 8, wherein the operating system includes an input device for inputting data by the person.

10. The method according to claim 1, wherein the authorization data are or include data concerning a charging contract and/or payment data.
